(19) United States
(12) Patent Application Publication
(10) Pub. No.: US 2014/0369515 A1
(43) Pub. Date: Dec. 18, 2014

(54) ENVIRONMENTAL NOISE REDUCTION

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/207,365

(22) Filed: Mar. 12, 2014

Related U.S. Application Data
(60) Provisional application No. 61/778,159, filed on Mar. 12, 2013.

(51) Int. Cl. H04R 3/00

(52) U.S. Cl. CPC H04R 3/002
USPC 381/71.1

(57) ABSTRACT

A Noise Control Process for targeted environments is disclosed. According to one embodiment, an input audio source corresponding to sound received from a group of microphones placed at certain locations in the targeted environment, is converted to a digital signal via an analog to digital (A/D) convertor. The ND converted audio is analyzed for content to identify ambient noise. The frequency, amplitude and phase of the identified ambient noise is subsequently determined. A Noise correction sound wave is generated with negative phase of that corresponding to the identified ambient noise. The noise correction sound wave is added to the identified noise to create a noise corrected sound.

### CROSS-REFERENCE TO RELATED PATENT APPLICATIONS

Embodiments of the present invention relate to U.S. Provisional Application Ser. No. 61/778,159, filed Mar. 12, 2013, entitled “ENVIRONMENTAL NOISE REDUCTION”, the contents of which are incorporated by reference herein and which is a basis for a claim of priority.

### BACKGROUND OF THE INVENTION

The present invention relates to a method and system for enhancing an audio source by reducing and eliminating background and other ambient noise emanating from large arenas such as stadiums, freeways, airports, outdoor concert complexes and the like.

In many areas where there are large arena that is a source of considerable noise, such as a stadium, airport and the like, there are also residential areas in the vicinity. This creates noise abatements for the stadiums that must be adhered to under penalty of law. The more people are involved in an event at one of these locations, the louder the noise level will be. Normally some type of acoustic absorption is used at great expense and with small amounts of noise level control. Some events even have a curfew, or specific time that they cannot go past in an event.

Noise control or noise mitigation is a set of strategies to reduce noise pollution or to reduce the impact of that noise, whether outdoors or indoors. The main areas of noise mitigation or abatement are: transportation noise control, architectural design, urban planning through zoning codes, and occupational noise control. Roadway noise and aircraft noise are the most pervasive sources of environmental noise worldwide, and little change has been effected in source control in these areas since the start of the problem, a possible exception being the development of hybrid and electric vehicles. Social activities may generate noise levels that consistently affect the health of populations residing in or occupying areas, both indoor and outdoor, near entertainment venues that feature amplified sounds and music that present significant challenges for effective noise mitigation strategies¹. ¹http://en.wikipedia.org/wiki/Noise_control

Multiple techniques have been developed to address interior sound levels, many of which are encouraged by local building codes; in the best case of project designs, planners are encouraged to work with design engineers to examine trade-offs of roadway design and architectural design. These techniques include design of exterior walls, party walls, and floor and ceiling assemblies; moreover, there are a host of specialized means for damping reverberation from special-purpose rooms such as auditoria, concert halls, entertainment and social venues, dining areas, audio recording rooms, and meeting rooms. Many of these techniques rely upon materials science applications of constructing sound baffles or using sound-absorbing liners for interior spaces. Industrial noise control is really a subset of interior architectural control of noise, with emphasis upon specific methods of sound isolation from industrial machinery and for protection of workers at their task stations². ² See, n.1, above.

A new noise cancelation method and process is required that addresses the above noted deficiencies of the conventional noise reduction methods.

### SUMMARY OF THE INVENTION

The Environmental Noise Reduction (“ENR”) system and process comprises a software for decreasing ambient noise in an outside environment. This will typically be used in a computer to form a system. This system is dynamic in that it is constantly monitoring and changing as the ambient noise in the environment changes. The system consists of both analog and digital components. The microphones in the structure are laid out in equal distances and monitor both its own zone and the overlaps of any zones around it. The number of microphones and zones will be determined by the size of the structure the system is used in. They are all converted to digital and fed into a computer that will analyze, compare, and change each zone as needed in real time. A single zone will have multiple filters with varying frequencies and widths.

The inventive ENR process and system is used for decreasing the amount of noise from outdoor environments such as stadiums, traffic, airports and other outdoor areas with noise problems. The typical system will consist of some type of computer running the software process, microphonic transducers, and amplified audio transducer system for transmission of the phase shifted audio. The use will determine the exact type of transducers used in a given system.

The inventive ENR is a process and system comprising both analog and digital components that is specifically designed for reducing and eliminating ambient noise emanating from large outdoor arenas. The method and system is dynamic in that it continuously monitors and changes as the noise in the targeted environment changes.

The inventive ENR system includes microphones that are placed in the target cabin in which noise reduction is sought, preferably microphones are situated certain locations and configurations throughout the targeted environment. Each microphone monitors sound waves in its corresponding zone and the overlaps of any of its surrounding zones. The number of microphones and zones will be determined by the size of the targeted environment the system is used in. Preferably, the microphones are of the Cardioids type.

The signals from the microphones are fed to an analog to digital converter, which converts the analog signals received from the microphones to digital signals. The converted digital audio is analyzed for content and noise is identified for further processing. The ambient noise is monitored for changes.

Changes to the amplitude, frequency and phase of the ambient noise are subsequently performed as necessary. Phase Modulator dynamically changes the phase of the ambient noise, always in a negative amount, of the digital audio received. The negative phase sound is added back to the original noise which results in a reduction or cancellation of the sound wave corresponding to the noise. These changes are dynamic and self adjusting in nature. The modified, noise corrected digital sound output is changed back to an analog signal and fed into the audio playback system for noise reduction.

### BRIEF DESCRIPTION OF THE DRAWINGS

FIG. 1 is a schematic diagram of an exemplary embodiment of the Environmental Noise Rontrol Module according to the present invention showing a stadium in proximity to a residential area.

FIG. 2 is a schematic diagram of an exemplary embodiment showing the areas which are the through which noise is projected onto a residential area according to an embodiment of the present invention.

FIG. 3 is an exemplary illustration of location and placement of microphones according to an embodiment of the present invention.

FIG. 4 is a block diagram showing the signal flow according to an embodiment of the present invention.

### DETAILED DESCRIPTION OF THE PREFERRED EMBODIMENT(S)

Details of the present invention will now be discussed by reference to the drawings.

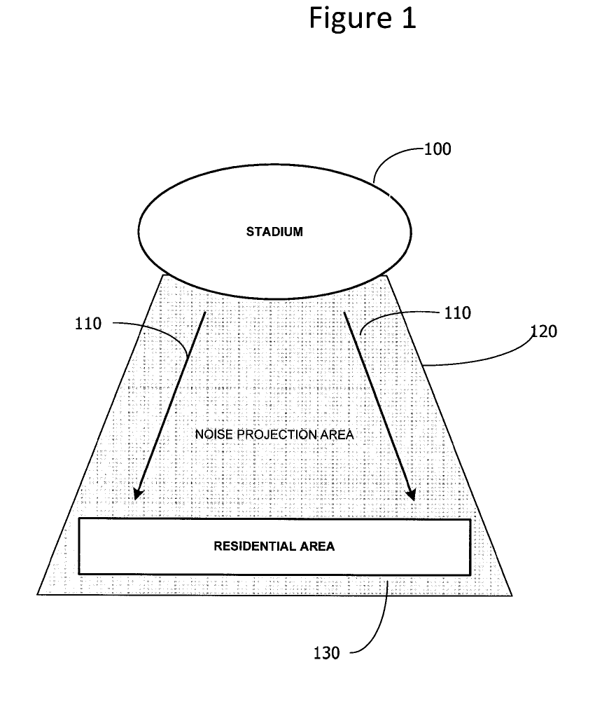

FIG. 1 is a schematic diagram of a typical stadium 100 to which the inventive ENR is applied. The stadium 100 is in proximity to a residential neighborhood 130. Reference numeral 110 corresponds to the arrows that show the direction of the undesirable noise from the stadium 100 to the residential area 130 that the present invention seeks to curb. Zone 120 is targeted for noise reduction according to this embodiment.

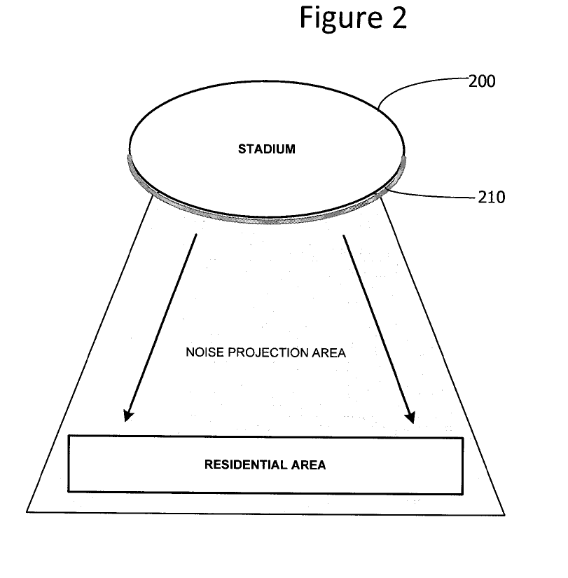

FIG. 2 is a schematic diagram depicting a periphery 210 of the stadium 200 through which noise reduction is sought according to an embodiment of the present invention. The periphery 210 highlights the area that is the focus of the inventive noise control efforts to diminish and reduce noise that originates from the stadium 200 and passes on to the residential area.

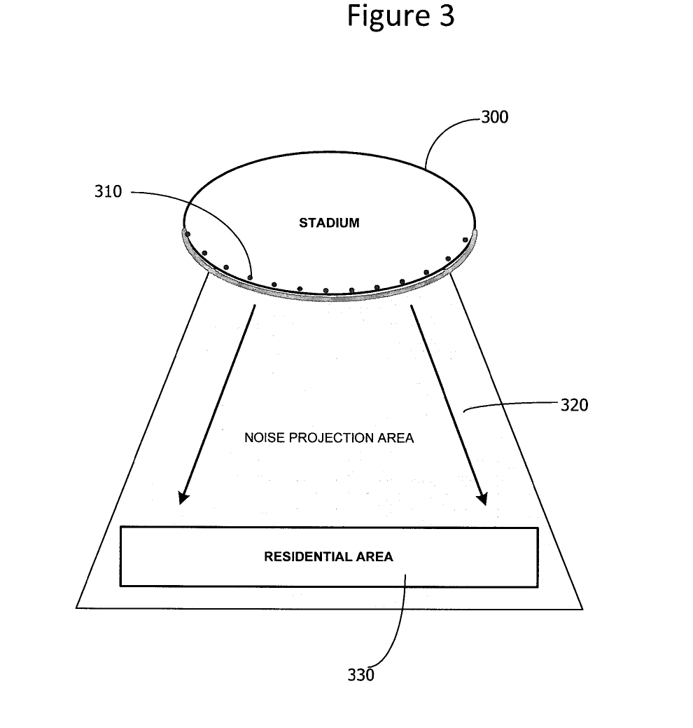

FIG. 3 is a schematic diagram depicting the placement and arrangement of microphones according to an embodiment of the present invention. The dotted line 310 represents a group of microphones that monitor the audio coming from the inside of the stadium 300. Preferably, the microphones 310 are of the Cardioid type. Preferably the microphones are spread in equal distances from each other along periphery (identified as reference numeral 210 in FIG. 2) of stadium 300.

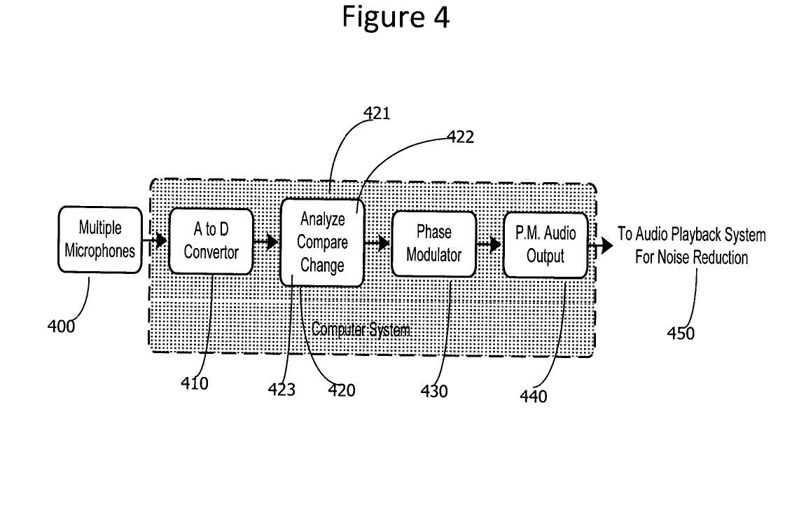

FIG. 4 is a block diagram showing the operation of the present invention according to an exemplary embodiment. The input audio from group of microphones 400 is fed to an analog-to-digital (A/D) convertor 410, where the input audio analog signal is converted to a digital format.

The converted digital audio from the A/D convertor 410 is fed to the inventive Environmental Noise Cancellation (ENC) module 20 for processing. The Noise Control Processor Module 420 performs several steps on the sound wave it receives from the A/D converter which will ultimately result in an audio sound with reduced or cancelled ambient noise levels.

In the Analyze step 421, A/D converted audio sound 410 is analyzed for content and ambient noise is identified. Once the noise wave is identified, it is further analyzed for frequency, amplitude and phase values. Compare step 422 monitors the amplitude, frequency and phase of the original sound wave for changes to ambient noise are subsequently performed as needed to identify any additions or changes to the determined noise. Change step 423 identifies any changes that are needed to be made to the incoming digital noise in both positive and negative direction, in the identified ambient noise.

Phase Modulator step 430 dynamically changes the phase of the identified ambient noise, in a negative amount, and creates a new noise correction wave based on the digital audio received. These changes are dynamic and self adjusting in nature.

Phase Modulator Audio Output step 440 is a phase modulated audio output (digital or analog) that feeds into the existing audio system in the targeted environment. In this step the modified noise output from the Phase Modulator 430 is added back to the original noise in a phase shift of 90 to 180 degrees as needed to cancel out the input noise.

The resulting combination of the original noise sound waves and the newly created noise correction wave will result in a reduction and cancellation of the noise present in the original audio sound. This Phase Modulation is a constantly changing amount. The amount of change is derived from the analyzing of the input noise and its amplitude plus harmonic content.

What is claimed is:

1. A Noise Control System and Process for an outside environment comprising:
Providing an input audio source from a targeted environment;
Converting the input audio source to a digital signal via an analog to digital (A/D) convertor;
Analyzing the A/D converted audio for content and identifying ambient noise;
Determining frequency, amplitude and phase of the identified ambient noise;
Generating a noise correction sound wave with negative phase of that corresponding to the identified ambient noise;
Summing the noise correction sound wave and the identified noise sound wave to create a noise corrected audio sound wave.
Outputting the noise corrected audio sound with diminished noise.

2. The Noise Control Process of claim 1 wherein the negative phase is a phase shifted wave with a shift of between 90 and 180 degrees from the original phase amount.

3. The Noise Control process of claim 1 further comprising monitoring the A/D converted audio for changes in the ambient noise and identifying any additional noise waves.

4. The Noise Control Process of claim 1, wherein the input audio source is received from multiple microphones situated in the targeted environment.

5. The Noise Control Process of claim 4, wherein the microphones are of Cardiod type.

6. The Noise Control Process of claim 4, wherein the targeted environment is an airplane cabin.
